(19) United States
(12) Patent Application Publication
(10) Pub. No.: US 2011/0154920 A1
(43) Pub. Date: Jun. 30, 2011

(54) ACTUATOR WITH THRUST FLANGES AND LATERALLY TILTABLE TOOL ASSEMBLY USING SAME

(76) Inventor: Dean R. Weyer, Enumclaw, WA (US)

(21) Appl. No.: 12/954,465

(22) Filed: Nov. 24, 2010

Related U.S. Application Data
(60) Provisional application No. 61/264,630, filed on Nov. 25, 2009.

(51) Int. Cl. F16H 25/08

(52) U.S. Cl. 74/25

(57) ABSTRACT

A fluid-powered rotary actuator having a body with a shaft disposed therein and having a linear-to-rotary torque transmitting member mounted for longitudinal movement within said body in response to the selective application of pressurized fluid thereto. The body includes a non-cylindrical cross-sectional shape body portion and a non-cylindrical cross-sectional shape piston head is in sliding engagement therewith and sized to engage the body portion to inhibit rotation of the piston head. In an alternative embodiment the body portion is cylindrical with an eccentric aperture to receive the shaft to inhibit rotation of the piston head.

### BACKGROUND OF THE INVENTION

1. Field of the Invention

The present invention relates generally to actuators and laterally tiltable tool assemblies, and more particularly, to fluid-powered rotary actuators in which axial movement of a piston results in relative rotational movement between a body and a shaft, and laterally tiltable tool assembly using same.

2. Description of the Related Art

Rotary helical splined actuators have been employed in the past to achieve the advantage of high-torque output from a simple linear piston-and-cylinder drive arrangement. The actuator typically uses a cylindrical body with an elongated rotary output shaft extending coaxially within the body, with an end portion of the shaft providing the drive output. An elongated annular piston sleeve has a sleeve portion splined to cooperate with corresponding splines on the body interior and the output shaft exterior. The piston sleeve is reciprocally mounted within the body and has a piston head portion for the application of fluid pressure to one or the other opposing sides thereof to produce axial movement of the piston sleeve.

As the piston sleeve linearly reciprocates in an axial direction within the body, outer helical splines of the sleeve portion engage helical splines of the body to cause rotation of the sleeve portion. The resulting linear and rotational movement of the sleeve portion is transmitted through inner helical splines of the sleeve portion to helical splines of the shaft to cause the shaft to rotate. Bearings are typically supplied to rotatably support one or both ends of the shaft relative to the body.

Reducing the cost and size of fluid-powered rotary actuators and increasing their durability are an almost always present challenge. This challenge is applicable when manufacturing a laterally tiltable tool assembly to be connected to an extendable or articulated arm of a backhoe, excavator and similar type vehicle and using a fluid-powered rotary actuator to provide the rotational drive for laterally tilting a bucket or other tool attached to the tool assembly. Such laterally tiltable tool assemblies are used under harsh conditions where debris, dust, dirt and moisture is most often present and experience high load conditions.

It will be therefore be appreciated that there has long been a significant need for fluid-powered rotary actuators that require less expensive to manufacture, has a reduced length and is durable. The present invention fulfills these needs and further provides other related advantages.

### BRIEF DESCRIPTION OF THE SEVERAL VIEWS OF THE DRAWING(S)

FIG. 1 is a front right side perspective view of an excavator shown with one version of a laterally tiltable tool assembly with a fluid-powered rotary actuator embodying the present invention, shown with a bucket attached and showing other attachable tools on the ground.

FIG. 2 is an enlarged, fragmentary, right side, cross-sectional view of a first embodiment of the tool assembly of FIG. 1, shown taken substantially along the line A-A of FIG. 2A.

FIG. 2A is a partial rear end view of the tool assembly of FIG. 2.

FIG. 2B is a partial cross-sectional view of the tool assembly of FIG. 2, shown taken substantially along the line B-B of FIG. 2.

FIG. 3 is an enlarged, fragmentary, right side, cross-sectional view of a second embodiment of the rotary actuator useable with the tool assembly of FIG. 1, shown taken substantially along the line A-A of FIG. 3A.

FIG. 3A is a rear end view of the rotary actuator of FIG. 3.

FIG. 3B is a cross-sectional view of the rotary actuator of FIG. 3, shown taken substantially along the line B-B of FIG. 3.

FIG. 4 is an enlarged, fragmentary, left side, cross-sectional view of a third embodiment of the rotary actuator useable with the tool assembly of FIG. 1, shown taken substantially along the line A-A of FIG. 4A.

FIG. 4A is a rear end view of the rotary actuator of FIG. 4.

FIG. 4B is a cross-sectional view of the rotary actuator of FIG. 4, shown taken substantially along the line B-B of FIG. 4.

FIG. 5 is an enlarged, fragmentary, right side, cross-sectional view of a fourth embodiment of the rotary actuator useable with the tool assembly of FIG. 1, shown taken substantially along the line A-A of FIG. 5A.

FIG. 5A is a rear end view of the rotary actuator of FIG. 5.

FIG. 5B is a cross-sectional view of the rotary actuator of FIG. 5, shown taken substantially along the line B-B of FIG. 5 using an oval piston head and a concentric shaft.

FIG. 5B-1 is a cross-sectional view of the rotary actuator of FIG. 5, shown taken substantially along the line B-B of FIG. 5 using a square piston head and a concentric shaft.

FIG. 5B-2 is a cross-sectional view of the rotary actuator of FIG. 5, shown taken substantially along the line B-B of FIG. 5 using a cylindrical piston head and an eccentric shaft.

### DETAILED DESCRIPTION OF THE INVENTION

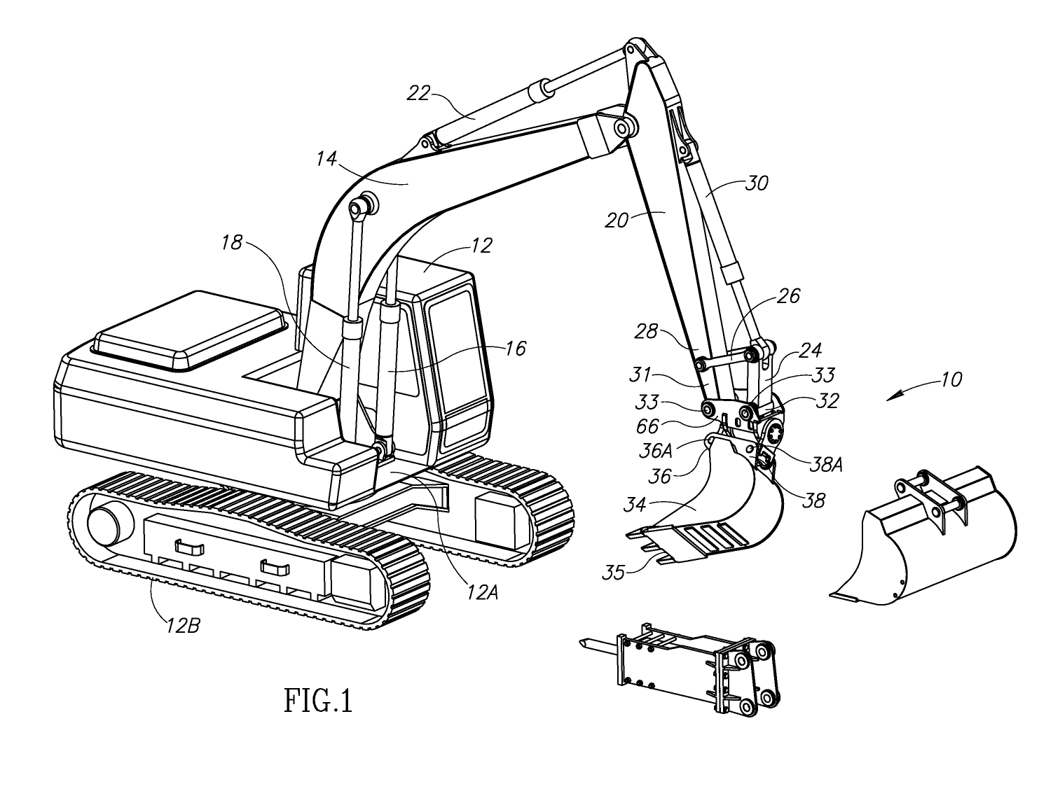

As shown in the drawings for purposes of illustration, a first embodiment of the invention is embodied in a fluid-powered, laterally tiltable tool assembly, indicated generally by reference numeral 10, and a fluid-powered rotary actuator, indicated generally by reference numeral 40. As shown in FIG. 1, the tool assembly 10 is usable with a vehicle 12, such as the illustrated excavator or any other suitable type vehicle such as a backhoe that might use a bucket or other tool as a work implement. The vehicle 12 has a first arm 14 which is pivotally connected by one end to a base member (not shown) forming a part of the platform 12A of the vehicle. A pair of hydraulic cylinders 16 and 18 are provided for raising and lowering the first arm in a generally forwardly extending vertical plane with respect to the base member. A second arm 20 is pivotally connected by one end to an end of the first arm 14 remote from the base member. A hydraulic cylinder 22 is provided for rotation of the second arm 20 relative to the first arm 14 in the same vertical forward rotation plane as the first arm operates.

The platform 12A of the vehicle 12 is pivotally mounted and supported by a track drive undercarriage 12B and is pivotally movable about a vertical axis so as to permit movement of the first and second arms 14 and 20 in unison to the left or right, with the first and second arms always being maintained in the forward rotation plane. It is noted that while the forward rotation plane is referred to as being forwardly extending for convenience of description, as the platform 12A is pivoted relative to the track drive, the forward rotation plane turns about the vertical pivot axis of the track drive and thus to a certain extent loses its forward-to-rearward orientation, with the plane actually extending laterally relative to the undercarriage 12B should the platform be sufficiently rotated.

A rotation link 24 is pivotally connected through a pair of interconnecting links 26 to an end portion 28 of the second arm 20 remote from the point of attachment of the second arm to the first arm 14. A hydraulic cylinder 30 is provided for selective movement of the rotation link 24 relative to the second arm 20.

As is conventional, a free end portion 31 of the second arm 20 and a free end portion 32 of the rotation link 24 each has a transverse aperture therethrough for connection of the second arm and the rotation link to a conventional tool such as a bucket using a pair of selectively removable attachment pins 33. The attachment pins 33 are insertable in the apertures to pivotally connect the conventional tool directly to the second arm and the rotation link. When using the conventional tool, this permits the tool to be rotated about the attachment pin of the second arm 20 upon movement of the rotation link 24 relative to the second arm as a result of extension or retraction of the hydraulic cylinder 30 to rotate the conventional tool in the forward rotation plane defined by the first and second arms 14 and 20.

In the embodiment of the invention shown in FIG. 1, a conventional bucket 34 of relatively narrow width is utilized. The bucket has a toothed working edge 35 extending laterally, generally transverse to the forward rotation plane of the bucket. The bucket 34 further includes a first and second bucket devises 36 and 38, with the first bucket clevis located toward the bucket working edge 35 and second bucket clevis 38 located forwardly of the first bucket clevis and away from the bucket working edge. The first and second bucket devises are in general parallel alignment with the forward rotation plane of the bucket. It should be understood that the present invention may be practiced using other tools as work implements, and is not limited to just operation with buckets.

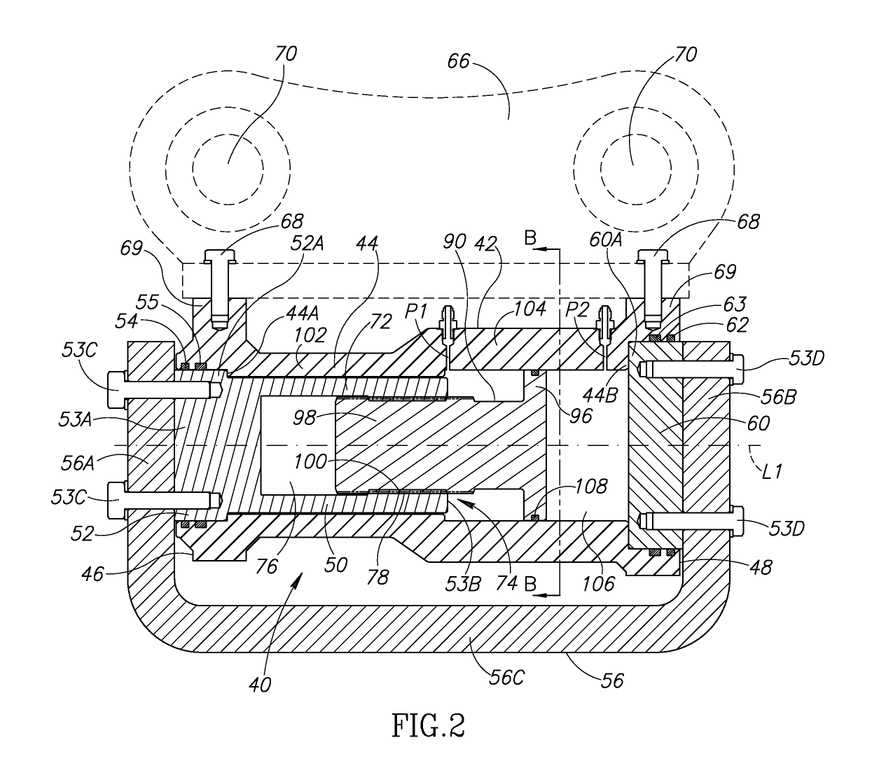

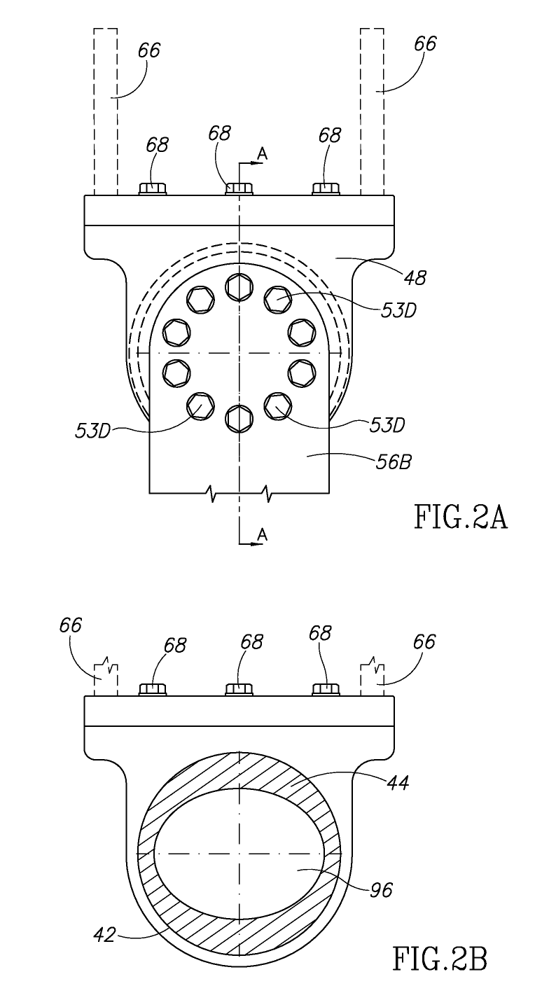

The tool assembly 10 includes the fluid-powered rotary actuator 40. One version of the rotary actuator 40 is shown in FIGS. 2, 2A and 2B. The rotary actuator 40 has an elongated housing or body 42 with a body sidewall 44 and first and second body ends 46 and 48, respectively. An axially outward facing first body end shoulder 44A is located axially inward from the first body end 46, and an axially outward facing second body end shoulder 44B is located axially inward from the second body end 48. An elongated rotary drive or output shaft 50 is coaxially positioned within the body 42 and supported for rotation relative to the body about a longitudinal axis L1.

The shaft 50 extends partially along length of the body 42 from the first body end 46 to about midway to the second body end 48, and has a flange portion 52 at the first body end 46 with an axially inward facing flange shoulder 52A in sliding engagement with the axially outward facing first body end shoulder 44A of the body sidewall 44. The shaft has a shaft first end portion 53A at the first body end 46 which extends axially outward beyond the first body end and a shaft second end portion 53B toward the second body end 48.

An exclusion seal 54 and a pressure seal 55 are disposed between the periphery of the shaft flange portion 52 and the body sidewall 44 at the first body end 46 to provide a fluid-tight seal and containment seal therebetween. The shaft flange portion 52 engages body 42 at the first body end 46 in the area between the pressure seal 55 and its axially inward facing flange shoulder 52A for sliding rotary motion and radial load transfer.

A saddle or “C”-shaped attachment frame 56 is positioned outward of the body 42 and has a first end leg 56A at the first body end 46 and a second end leg 56B at the second body end 48, with a mid-portion member 56C spanning between the first and second end legs. The first end leg 56A is rigidly attached to the shaft first end portion 53A at the first body end 46 for rotation with the shaft 50 relative to the body 42, with the first end leg being spaced axially apart from the first body end. The first end leg 56A abuts against an outward end face of the shaft first end portion 53A for support and is bolted thereto by a plurality of circumferentially arranged bolts 53C (only two being illustrated in FIG. 2).

The attachment frame 56 has the rotational drive of the shaft 50 transmitted thereto so as to provide the torque needed for tilting the bucket 34 (or other tool attached to the tool assembly 10) to the desired lateral tilt angle and for holding the bucket in that position while the bucket performs the desired work. The attachment frame 56 does not move axially relative to the body 42.

The first end leg 56A and the second end leg 56B of the attachment frame 56 extend radially beyond the body sidewall 44 generally downwardly toward the bucket 34. The mid-portion member 56C extends between the first and second end legs 56A and 56B and is rigidly attached thereto, and extends generally parallel to the body sidewall 44 at a position below the body sidewall. The mid-portion member 56C of the attachment frame 56 is configured to be rigidly attached to a tool attachment assembly (not shown) spaced below and away from the rotary actuator 40 which can be operated to achieve releasable attachment thereto of a tool such as the bucket 34 shown in FIG. 1. Where the rotary actuator 40 of the present invention is not used in a laterally tiltable tool assembly 10 such as described above, the mid-portion member 56C may be affixed to another first device or structure and the body 42 attached to different second device or structure to accomplish relative rotational movement between the first device or structure and the second device or structure.

An end cap 60 is rotatably mounted within the body 42 at the second body end 48 and extends axially outward beyond the second body end. The end cap 60 has an axially inward facing end cap shoulder 60A in sliding engagement with the axially outward facing second body end shoulder 44B of the body sidewall 44. The second end leg 56B of the attachment frame 56 abuts against an outward end face of the end cap 60 and is bolted thereto by a plurality of circumferentially arranged bolts 53D, with five bolts 53D illustrated in FIG. 2A.

An exclusion seal 62 and a pressure seal 63 are disposed between the periphery of the end cap 60 and the body sidewall 44 at the second body end 48 to provide a fluid-tight seal and containment seal therebetween. The end cap 60 engages the body 42 at the second body end 48 in the area between the pressure seal 63 and its axially inward facing end cap end cap shoulder 60A for sliding rotary motion and radial load transfer. The second end leg 56B of the attachment frame 56 is rigidly attached to the end cap 60 at the second body end 48 with the second end leg being spaced axially apart from the second body end. Through the attachment frame 56, the end cap 60 is effectively attached to the shaft first end portion 53A of the shaft 50 at the first body end 46 and the rotational drive the shaft applies to the attachment frame is transmitted by the second end leg 56B to the end cap such that the end cap rotates with the shaft 50 relative to the body 42.

The tool assembly 10 includes a pair of attachment brackets 66 rigidly attached to the body 42 of the rotary actuator 40 by a plurality of bolts 68, each of which threadably engage an interiorly threaded attachment 69 of the body. The attachment brackets 66 are used to detachably connect the tool assembly 10 to the second arm 20 and the rotation link 24 in a position therebelow in general alignment with the forward rotation plane, much in the same manner as a conventional bucket would be attached. The attachment brackets 66 form first and second attachment clevis with apertures 70 therein each sized to receive one of the attachment pins 33 to pivotally connect the tool assembly 10 to the vehicle second arm 20 at its free end portion 31, and to pivotally connect the tool assembly to the rotation link 24 at its free end portion 32. By the use of selectively removable attachment pins 33, the tool assembly 10 can be removed from the second arm 20 and the rotation link 24 when use of the tool assembly is not desired.

The shaft 50 has an annular second end shaft portion 72 extend from the shaft first end portion 53A toward the second body end 48. The second end shaft portion 72 has an opening 74 at its end toward the second body end and defines an open ended cylindrical in cross-sectional shape, interior chamber 76 coaxial with the body sidewall 44. A portion of the length of the interior chamber 76, toward the second body end 48, has inner helical splines 78.

The rotary actuator 40 uses a piston 90 coaxially and reciprocally mounted within the body 42 coaxially with the shaft 50. The piston 90 has a piston head 96 toward the second body end 48 and a splined portion 98 rigidly attached to the piston head and extending therefrom toward the first body end 46. The splined portion 98 is sized to extend within the interior chamber 76 of the second end shaft portion 72 of the shaft 50 and has outer helical splines 100 over a portion of its length which slidably mesh with inner helical splines 78 of the interior chamber 76 of the shaft 50. It should be understood that while splines are shown in the drawings and described herein, the principle of the invention is equally applicable to any form of linear-to-rotary motion conversion means, such as balls or rollers, or other means.

In the first embodiment of the invention illustrated in FIG. 2, the piston head 96 of the piston 90 is non-cylindrical in cross-sectional shape and positioned toward the second body end 48. The piston head 96 is slidably maintained within the body 42 for reciprocal movement, and undergoes longitudinal but not rotational movement relative to the body sidewall 44. The body sidewall 44 of the body 42 of the rotary actuator 40 of this embodiment has a first end body sidewall portion 102 which is cylindrical in cross-sectional shape and extends from the first body end 46 to a body mid-portion, and a second end body sidewall portion 104 which has an exterior wall surface which is cylindrical in cross-sectional shape and an interior wall surface which is non-cylindrical in cross-sectional shape and extends from the axially outward facing second body end shoulder 44B to the body mid-portion where the first and second end body sidewall portions are joined together. The second end body sidewall portion 104 defines an interior chamber 106 which is non-cylindrical in cross-sectional shape and sized to slidably receive the piston head 96 therein. The interior sidewall surfaces of the first and second end body sidewall portions 102 and 104 are smooth. The piston head 96 of the piston 90 is disposed for reciprocation within only the non-cylindrical interior chamber 106 of the second end body sidewall portion 104 and has a perimeter with a cross-sectional shape corresponding to the non-cylindrical shape of the interior chamber 106 so as to be in sliding engagement therewith, in this case the piston head 96 and the interior chamber 106, as well as the second end body sidewall 104, are oval as shown in FIG. 2B. The splined portion 98 of the piston 90 is cylindrical in shape.

The annular second end shaft portion 72 of the shaft 50 of the rotary actuator 40 in this embodiment is cylindrical in cross-sectional shape and extends toward the second body end 48 about the same length as the first end body sidewall portion. The second end shaft portion 72 has a smooth exterior sidewall surface and is coaxially disposed within in the smooth-walled, cylindrical first end body sidewall portion 102 for rotation therewithin.

A seal 108 is carried by the piston head 96 of the piston 90 and disposed between the piston head and the smooth interior sidewall surface of the second end body sidewall portion 104 of the body sidewall 44 to provide a fluid-tight seal therebetween.

As will be readily understood, reciprocation of the piston 90 within the body 42 of the rotary actuator 40 occurs when hydraulic fluid, such as oil, air or any other suitable fluid, under pressure selectively enters through one or the other of a first port P1 which is in fluid communication with a fluid-tight compartment within the body defined to a side of the piston head 96 toward the first body end 46 or through a second port P2 which is in fluid communication with a fluid-tight compartment within the body to a side of the piston head toward the second body end 48. The application of fluid pressure to the first port P1 produces axial movement of the piston 90 toward the second body end 48. The application of fluid pressure to the second port P2 produces axial movement of the piston 90 toward the first body end 46. The rotary actuator 40 provides relative rotational movement between the body 42 and shaft 50 through the conversion of linear movement of the piston 90 into rotational movement of the shaft. The shaft 50 is selectively rotated by the application of fluid pressure, and the rotation is transmitted to the bucket 34 or other tool to selectively tilt the attached bucket or other tool laterally, left and right.

When hydraulic fluid under pressure is selectively applied to the first port P1 or the second port P2, the piston 96 will move longitudinally within the second end body sidewall portion 104, but the matching non-cylindrical shapes of the piston head 96 and the second end body sidewall portion prevent the rotation of the piston. Linear reciprocation of the piston head 96 in an axial direction within the second end body sidewall portion 104 of the body 42 of the rotary actuator 40, with the outer helical splines 100 of the splined portion 98 of the piston 90 engaging and meshing with the inner helical splines 78 of the interior chamber 76 of the shaft 50, causes the shaft to alternately rotate clockwise and counterclockwise. The axial movement of the piston 90 is converted into rotational movement of the shaft 50 through the interaction of the outer helical splines 100 of the splined portion 98 of the piston and the inner helical splines 78 of the interior chamber 76 of the shaft 50 because axial movement of the shaft is restricted. The axial movement of the shaft 50 in the direction of the second body end 48 is restricted by the axially inward facing flange shoulder 52A of the flange portion 52 of the shaft engaging the axially outward facing first body end shoulder 44A of the body sidewall 44 when axial force is experienced on the shaft in the direction of the second body end 48, and axial movement of the shaft 50 in the direction of the first body end 46 is restricted by the axially inward facing end cap shoulder 60A engaging the axially outward facing second body end shoulder 44B of the body sidewall when axial force is experienced on the shaft in the direction of the first body end 46 (the axial force in the direction of the first body end being transmitted to the end cap 60 by the attachment frame 56). The attachment frame 56 is sufficiently rigid and strong that limiting the axial movement of the end cap 60 toward the first body end 46 also limits the axial movement of the shaft 50 toward the first body end and retains the shaft within the body 42.

Since the shaft 50 cannot move in the axial direction, the interaction of the outer helical splines 100 and the inner helical splines 78 resulting from the axial movement of the piston 90 toward the second body end 48 when fluid pressure is applied to the first port P1 is converted into a rotational force on the shaft which drives the shaft to rotate in the clockwise or counterclockwise rotational direction depending on the direction of turn of the outer helical splines 100 and the inner helical splines 78, and when resulting from the axial movement of the piston toward the first body end 46 when fluid pressure is applied to the second port P2 is converted into a rotational force on the shaft which drives the shaft to rotate in the opposite rotational direction. Thus, all movement of the piston 90 is converted into rotational movement of the shaft 50. The rotational movement of the shaft 50 is transmitted by the shaft flange portion 52 to the attachment frame 56 and the tool attachment assembly (not shown) with the bucket 34 or other tool attached thereto, which results in lateral tilting of the bucket or other tool to the right or left.

The thrust loading of the actuator is now discussed. When fluid pressure is applied to the first port P1 to produce axial movement of the piston 90 toward the second body end 48, the pressurized fluid pushes the piston 96 in the axial direction toward the second body end 48 and transfers most of the load into the shaft 50 through the outer helical splines 100 of the splined portion 98 of the piston engaging the inner helical splines 78 of the interior chamber 76 of the shaft, thus biasing the shaft toward the second body end. This tends to engage the axially inward facing flange shoulder 52A with the axially outward facing first body end shoulder 44A at the first body end 46. The same pressurized fluid simultaneously also acts directly on the shaft flange portion 52 of the shaft 50, although in the opposite axial direction, to push it in the axial direction toward the first body end 46, thus biasing the shaft toward the first body end. This force is transmitted by the attachment frame 56 to the end cap 60 as an axial force in the direction toward the first body end and tends to engage the axially inward facing end cap shoulder 60A with the axially outward facing second body end shoulder 44B at the second body end 48. The net difference, adjusted for the frictional losses within the actuator 40 and the external force being applied to the shaft, determines the amount of axial force experienced by the thrust surfaces of the actuator, and whether the thrust surfaces at the first body end 46 or at the second body end 48 experience that axial force, i.e., either the axially inward facing flange shoulder 52A engaging the axially outward facing first body end shoulder 44A at the first body end 46, or the axially inward facing end cap shoulder 60A engaging the axially outward facing second body end shoulder 44B at the second body end 48. Since the area of the shaft flange portion 52 (defined by the diameter thereof) is only slightly smaller than the area of the piston 96 and since some force is lost to internal friction of the actuator 40, a relatively small net thrust force results from fluid pressure applied to the first port P1.

When fluid pressure is applied to the second port P2 to produce axial movement of the piston 90 toward the first body end 46, the pressurized fluid pushes the piston 96 in the axial direction toward the first body end 46 and transfers most of the load into the shaft 50 through the outer helical splines 100 of the splined portion 98 of the piston engaging the inner helical splines 78 of the interior chamber 76 of the shaft, thus biasing the shaft toward the first body end. This force is transmitted by the attachment frame 56 to the end cap 60 as an axial force in the direction toward the first body end and hence would be experienced by the axially inward facing end cap shoulder 602A engaging the axially outward facing second body end shoulder 44B at the second body end 48. However, the same pressurized fluid simultaneously also acts directly on the end cap 60, although in the opposite axial direction, to push it in the axial direction toward the second body end 48. Since the area of the end cap 60 (defined by the diameter thereof) is significantly greater than the area of the piston 96, the net thrust force resulting from fluid pressure applied to the second port P2 is axially outward in the axial direction toward the second body end 48 and is transmitted by the attachment frame 56 to the shaft flange portion 52 as an axial force in the direction toward the second body end, hence the net thrust force is experienced by the axially inward facing flange shoulder 52A engaging the axially outward facing first body end shoulder 44A at the first body end 46.

As the shaft 50 rotates, the axially inward facing flange shoulder 52A of the flange portion 52 can slide along the axially outward facing first body end shoulder 44A under a net axial thrust load in the axial direction of the second body end 48, and the axially inward facing end cap shoulder 60A of the end cap 60 can slide along the axially outward facing first body end shoulder 44B under a net axial thrust load in the axial direction of the first body end 46. While discussed above primarily with respect to the thrust forces experienced by the actuator 40 as a result of applying fluid pressure to the first and second ports P1 and P2, the thrust surfaces of the actuator (i.e., the thrust surfaces at the first body end 46—the axially inward facing flange shoulder 52A engaging the axially outward facing first body end shoulder 44A and the thrust surfaces at the second body end 48—the axially inward facing end cap shoulder 60A engaging the axially outward facing second body end shoulder 44B) also take up the axial loading experienced by the actuator from external sources such as loads on the bucket 34 or other tool attached to the tool assembly 10 and other loading experienced during operation of the actuator.

The pressure seal 55, which provides the fluid-tight seal therebetween the shaft flange portion 52 and the body sidewall 44 at the first body end 46, is located axially outward of the axially inward facing flange shoulder 52A and the axially outward facing first body end shoulder 44A so that the fluid applied to the first port P1 to produce axial movement of the piston 90 toward the second body end 48 also lubricates the inward facing flange shoulder 52A and the axially outward facing first body end shoulder 44A to reduce the friction therebetween and the wear resulting from the shaft 50 rotating. Further, the location of the seals 54 and 55 also places the area of engagement of the axially inward facing flange shoulder 52A with the axially outward facing first body end shoulder 44A within the sealed interior of the body 42 and thereby prevents debris, dust, dirt and moisture in the environment from engagement therewith and the damage and wear that would cause.

The pressure seal 63, which provides the fluid-tight seal therebetween the end cap 60 and the body sidewall 44 at the second body end 48, is located axially outward of the axially inward facing end cap shoulder 60A and the axially outward facing second body end shoulder 44B so that the fluid applied to the second port P2 to produce axial movement of the piston 90 toward the first body end 46 also lubricates the inward facing end cap shoulder 60A and the axially outward facing second body end shoulder 44B to reduce the friction therebetween and the wear resulting from the shaft 50 rotating. Further, the location of the seals 62 and 63 also places the area of engagement of the axially inward facing end cap shoulder 60A with the axially outward facing second body end shoulder 44B within the sealed interior of the body 42 and thereby prevents debris, dust, dirt and moisture in the environment from engagement therewith and the damage and wear that would cause.

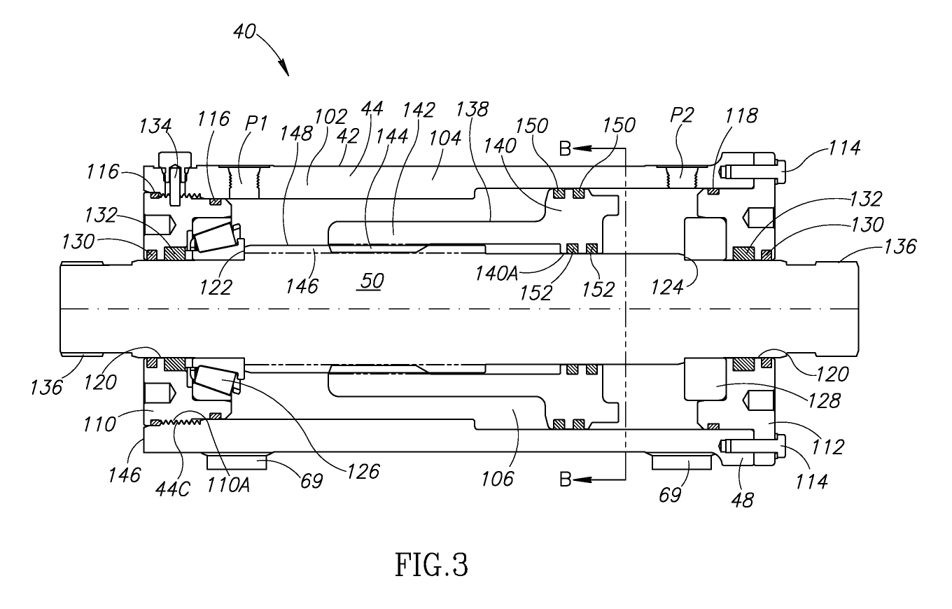

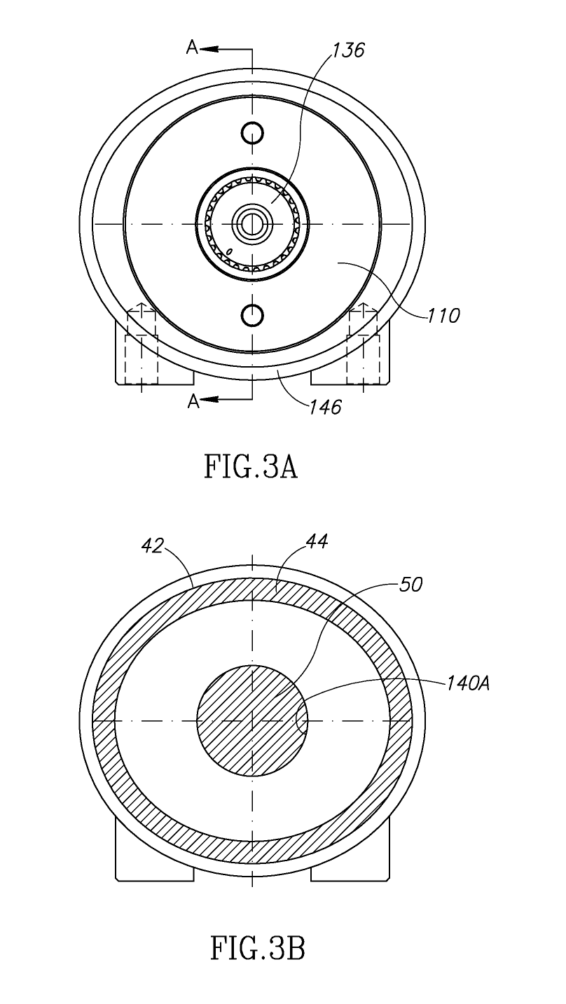

A second embodiment of the rotary actuator 40 useable as part of the tool assembly 10, or for other purposes is shown in FIGS. 3, 3A and 3B. The shaft 50 is coaxially positioned within the body 42 and supported for rotation relative to the body about the longitudinal axis of the body.

A first end cap 110 is threadably attached to the body 42 at the first body end 46 and a second end cap 112 is attached to the body at the second body end 48 by a plurality of circumferentially arranged bolts 114. The first end cap 110 has a threaded exterior perimeter portion 110A threadably attached to a correspondingly threaded interior portion 44C of the body sidewall 44 of the body 42 to retain the first end cap stationary relative to the body. A pair of seals 116 are disposed between the first end cap 110 and the body sidewall 44 at the first body end 46 to provide a fluid-tight seals therebetween. A seal 118 is disposed between the second end cap 112 and the body sidewall 44 at the second body end 48 to provide a fluid-tight seals therebetween.

The shaft 50 extends the full length of the body 42 and extends through a central aperture 120 in each of the first and second end caps 110 and 112. The shaft 50 has an axially outward facing first shaft shoulder 122 located axially inward from the first end cap 110, and an axially outward facing second shaft shoulder 124 located axially inward from the second end cap 112. An annular axial thrust bearings 126 is mounted on the shaft 50 in position between the first end cap 110 and the axially outward facing first shaft shoulder 122, and an annular axial thrust bearings 128 is mounted on the shaft 50 in position between the second end cap 112 and the axially outward facing second shaft shoulder 124. The annular axial thrust bearings 126 and 128 provide rotational, axial and radial support of the shaft 50 relative to the body 42. An exclusion seal 130 and a pressure seal 132 are disposed between the periphery of the shaft 50 and each of the first and second end caps 110 and 112 to provide a fluid-tight seal and containment seal therebetween. The first end cap 110 is locked in place against rotation relative to the body 42 during fluid-powered operation of the actuator 40 by a stop pin 134.

The shaft 50 extends outward of the body 42 through the apertures 120 in the first and second end caps 110 and 112, and has splined drive end portions extending beyond the first and second end caps for coupling to an external device (not shown) such as an attachment frame. It is to be understood that the rotary actuator 40 may be used with the shaft 40 rotatably driving an external device, or with the shaft being held stationary and the rotational drive being provided by rotation of the body 42.

The actuator 40 of the second embodiment of FIGS. 3, 3A and 3B has a linear-to-rotary transmission means which includes an annular piston sleeve 138 through which the shaft 50 extends. The piston sleeve 138 is coaxially and reciprocally mounted within the body 42 coaxially about the shaft 50. The piston sleeve 138 has a piston head 140 toward the second body end 48 with an aperture 140A sized to receive the shaft 50 therethrough. The aperture 140A being located coaxial with the body 42 and the shaft 50. The piston sleeve 138 further includes a splined portion 142 rigidly attached to the piston head and extending therefrom toward the first body end 46. The splined portion 142 has inner helical splines 144 over a portion of its length which slidably mesh with outer helical splines 146 of a splined intermediate portion 148 of the shaft 50 located between the first and second end caps 110 and 112, to a side of the piston head 140 toward the first body end 46. Again, while splines are shown in the drawings and described herein, the principle of the invention is equally applicable to any form of linear-to-rotary motion conversion means, such as balls or rollers, or other means.

As in the first embodiment of FIGS. 2, 2A and 2B, the piston head 140 of this second embodiment is non-cylindrical in cross-sectional shape and positioned toward the second body end 48. The piston head 140 is slidably maintained within the body 42 for reciprocal movement, and undergoes longitudinal but not rotational movement relative to the body sidewall 44. The body sidewall 44 of the body 42 of the rotary actuator 40 of this embodiment has the first end body sidewall portion 102 that is cylindrical in cross-sectional shape and extends from the first body end 46 to a body mid-portion, and has the second end body sidewall portion 104 which is non-cylindrical in cross-sectional shape (both the exterior and interior wall surfaces) and extends from axially inward of the second body end 48 to the body mid-portion where the first and second end body sidewall portions are joined together. The second end body sidewall portion 104 defines the interior chamber 106 which is non-cylindrical in cross-sectional shape and sized to slidably receive the piston head 140 therein. The interior sidewall surfaces of the first and second end body sidewall portions 102 and 104 are smooth. The piston head 140 of the piston sleeve 138 is disposed for reciprocation within only the non-cylindrical interior chamber 106 of the second end body sidewall portion 104 and has a perimeter with a cross-sectional shape corresponding to the non-cylindrical shape of the interior chamber 106 so as to be in sliding engagement therewith, in this case the piston head 140 and the interior chamber 106, as well as the second end body sidewall 104, are oval as shown in FIG. 3B. The splined portion 142 of the piston sleeve 138 is cylindrical in shape.

A pair of outer seals 150 are carried by the piston head 140 and disposed between the piston head and the smooth interior sidewall surface of the second end body sidewall portion 104 of the body sidewall 44 to provide a fluid-tight seal therebetween, and a pair of inner seals 152 are carried by the piston head and disposed between the head portion and a smooth exterior surface portion of the shaft 50 to provide a fluid-tight seal therebetween.

As for the first embodiment described above, reciprocation of the piston sleeve 138 within the body 42 of the rotary actuator 40 occurs when hydraulic fluid under pressure selectively enters through one or the other of a first port P1 which is in fluid communication with a fluid-tight compartment within the body defined to a side of the piston head 140 toward the first body end 46 or through a second port P2 which is in fluid communication with a fluid-tight compartment within the body to a side of the piston head toward the second body end 48. The application of fluid pressure to the first port P1 produces axial movement of the piston sleeve 138 toward the second body end 48. The application of fluid pressure to the second port P2 produces axial movement of the piston sleeve 138 toward the first body end 46. The rotary actuator 40 provides relative rotational movement between the body 42 and shaft 50 through the conversion of linear movement of the piston sleeve 138 into rotational movement of the shaft. The shaft 50 is selectively rotated by the application of fluid pressure, and the rotation is transmitted to the bucket 34 or other tool to selectively tilt the attached bucket or other tool laterally, left and right.

When hydraulic fluid under pressure is selectively applied to the first port P1 or the second port P2, the piston sleeve 138 will move longitudinally within the second end body sidewall portion 104, but the matching non-cylindrical shapes of the piston head 140 and the second end body sidewall portion prevent the rotation of the piston sleeve. Linear reciprocation of the piston head 140 in an axial direction within the second end body sidewall portion 104 of the body 42 of the rotary actuator 40, with the inner helical splines 144 of the splined portion 142 of the piston sleeve 138 engaging and meshing with the outer helical splines 146 of the splined intermediate portion 148 of the shaft 50, causes the shaft to alternately rotate clockwise and counterclockwise. Thus, all movement of the piston sleeve 138 is converted into rotational movement of the shaft 50. The rotational movement of the shaft 50 is transmitted by one or both of the splined drive end portions 136 of the shaft 50.

The axial movement of the piston sleeve 138 is converted into rotational movement of the shaft 50 through the interaction of the inner helical splines 144 of the splined portion 142 of the piston sleeve and the outer helical splines 146 of the splined intermediate portion 148 of the shaft 50 because axial movement of the shaft is restricted by the annular axial thrust bearings 126 and 128. When fluid pressure is applied to the first port P1 to produce axial movement of the piston 90 toward the second body end 48, the inner helical splines 144 engage the outer helical splines 146 and apply an axial force or thrust load on the shaft in an axial direction toward the second body end. This axial thrust load on the shaft 50 drives the shaft toward the second body end 48 and the axially outward facing second shaft shoulder 124 of the shaft against the annular axial thrust bearing 128, which limits the axial movement of the shaft toward the second body end. Since the shaft 50 cannot move further in the axial direction, as a result of the interaction of the inner helical splines 144 and the outer helical splines 146 the axial movement of the piston sleeve 138 toward the second body end 48 is converted into a rotational force on the shaft which drives the shaft to rotate in the clockwise or counterclockwise rotational direction depending on the direction of turn of the inner helical splines 144 and the outer helical splines 146.

The seal 132, which provides the fluid-tight seal therebetween the second end cap 112 and the body sidewall 44 at the second body end 48, is located axially outward of the annular axial thrust bearing 128 so the residual fluid that has been applied to the second port P2 to produce axial movement of the piston sleeve 138 toward the first body end 46 lubricates the annular axial thrust bearing 128. Further, the location of the seals 130 and 132 at the second body end 48 also places annular axial thrust bearing 128 within the sealed interior of the body 42 and thereby prevents debris, dust, dirt and moisture in the environment from engagement therewith and the damage and wear that would cause.

When fluid pressure is applied to the second port P2 to produce axial movement of the piston sleeve 138 toward the first body end 46, the inner helical splines 144 engage the outer helical splines 146 and apply an axial force or thrust load on the shaft in an axial direction toward the first body end. This axial thrust load on the shaft 50 drives the shaft toward the first body end 46 and the axially outward facing first shaft shoulder 122 of the shaft against the annular axial thrust bearing 126, which limits the axial movement of the shaft toward the first body end. Since the shaft 50 cannot move further in the axial direction, as a result of the interaction of the inner helical splines 144 and the outer helical splines 146 the axial movement of the piston sleeve 138 toward the first body end 46 is converted into a rotational force on the shaft which drives the shaft to rotate in the opposite rotational direction than when fluid pressure is applied to the first port P1.

The seal 132, which provides the fluid-tight seal between the first end cap 110 and the body sidewall 44 at the first body end 46, is located axially outward of the annular axial thrust bearing 126 so the residual fluid that has been applied to the first port P1 to produce axial movement of the piston sleeve 138 toward the second body end 48 lubricates the annular axial thrust bearing 126. Further, the location of the seals 130 and 132 at the first body end 46 also places annular axial thrust bearing 126 within the sealed interior of the body 42 and thereby prevents debris, dust, dirt and moisture in the environment from engagement therewith and the damage and wear that would cause.

While the non-cylindrical piston head 96 of the piston 90 of the first embodiment, the non-cylindrical piston head 140 of the piston sleeve 138 of the second embodiment, and the non-cylindrical second end body sidewall 104 of both embodiments are only illustrated as being oval in cross-section, many other non-cylindrical shapes can be used for the piston head and second end body sidewall portion which allow linear sliding movement of the piston within the second end body sidewall portion but yet limit rotational movement of the piston within the second end body sidewall portion. These would include square, triangular and the like, and other non-cylindrical shapes. While matching cross-sectional shapes for the non-cylindrical piston heads 96 and 140 and the non-cylindrical second end body sidewall portion 104 are described, these shapes do not have to have the same cross-sectional shape just so the shapes for each selected prevent the rotation of the piston heads (and hence the piston 90 and the piston sleeve 138) within the second end body sidewall portion 104 as the piston/piston sleeve linearly reciprocates therein as the rotary actuator 40 is operated under fluid power.

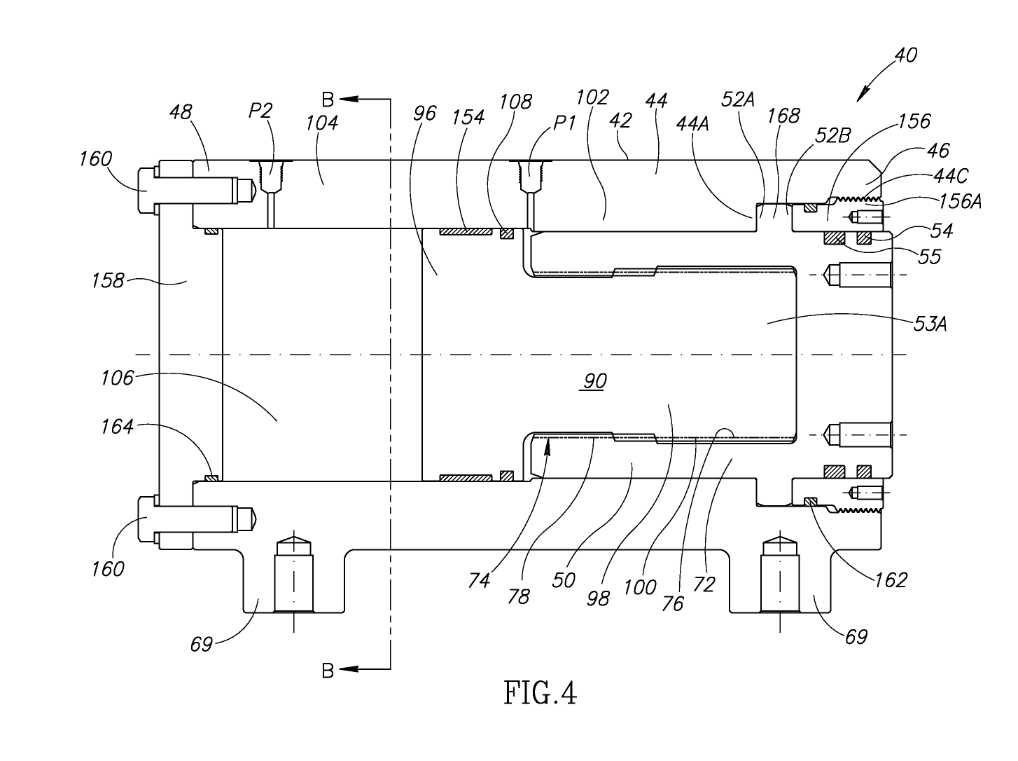

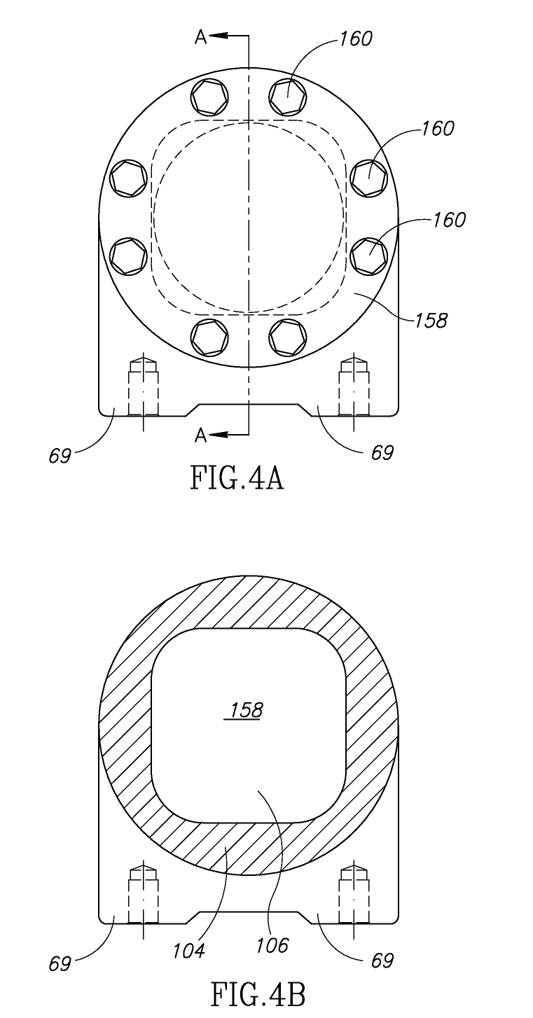

One alternative non-cylindrical in cross-sectional shape is shown in a third embodiment of the rotary actuator 40 illustrated in FIGS. 4, 4A and 4B. The rotary actuator 40 is very similar to the design of the embodiment of FIG. 2 except that instead of having the piston head 96 being oval, it is generally square in cross-sectional shape with rounded corners. It is noted that the rotary actuator of FIG. 4 is shown from the opposite side so the first and second body ends 46 and 48 appear reversed. In this embodiment a radial bearing 154 is carried by the piston head 96 and disposed between the piston head and the smooth interior sidewall surface of the second end body sidewall portion 104 of the body sidewall 44.

A further difference is use of a first end cap 156 threadably attached to the body 42 at the first body end 46 and a second end cap 158 attached to the body at the second body end 48 by a plurality of circumferentially arranged bolts 160. The first end cap 156 has a threaded exterior perimeter portion 156A threadably attached to a correspondingly threaded interior portion 44C of the body sidewall 44 of the body 42 to retain the first end cap stationary relative to the body. A seal 162 are disposed between the first end cap 156 and the body sidewall 44 at the first body end 46 to provide a fluid-tight seals therebetween. A seal 164 is disposed between the second end cap 158 and the body sidewall 44 at the second body end 48 to provide a fluid-tight seals therebetween. The shaft first end portion 53A extends through a central aperture 166 in the first end cap 156.

Another difference is that the shaft first end portion 53A has a shaft flange 168 positioned between the axially outward facing first body end shoulder 44A and the first end cap 156. The shaft flange 168 has the axially inward facing flange shoulder 52A of the shaft 50 formed thereon and is in sliding engagement with the axially outward facing first body end shoulder 44A of the body sidewall 44 to restrict axial movement of the shaft 50 toward the second body end 48. Also, the flange 168 also includes an axially outward facing flange shoulder 52B in sliding engagement with an axially inward facing side of the first end cap 156 to restrict axial movement of the shaft 50 toward the first body end 46.

The seal 162, which provides the fluid-tight seal between the first end cap 156 and the body sidewall 44 at the first body end 46, and the pressure seal 55, which provides the fluid-tight seal between the first end cap and the shaft first end portion 53A, are located axially outward of the shaft flange 168. As such, when the shaft 50 rotates the residual fluid that has been applied to the first port P1 to produce axial movement of the piston sleeve 138 toward the second body end 48 lubricates the shaft flange 168 and hence lubricates the sliding engagement between the inward facing flange shoulder 52A and the axially outward facing first body end shoulder 44A and between the outwardly facing flange shoulder 52B and the axially inward facing side of the first end cap 156 to reduce the friction therebetween and the wear resulting from the shaft 50 rotating. Further, the location of the seals 54, 55 and 162 also places the shaft flange 168 which serves as an axial and radial thrust bearing within the sealed interior of the body 42 and thereby prevents debris, dust, dirt and moisture in the environment from engagement therewith and the damage and wear that would cause.

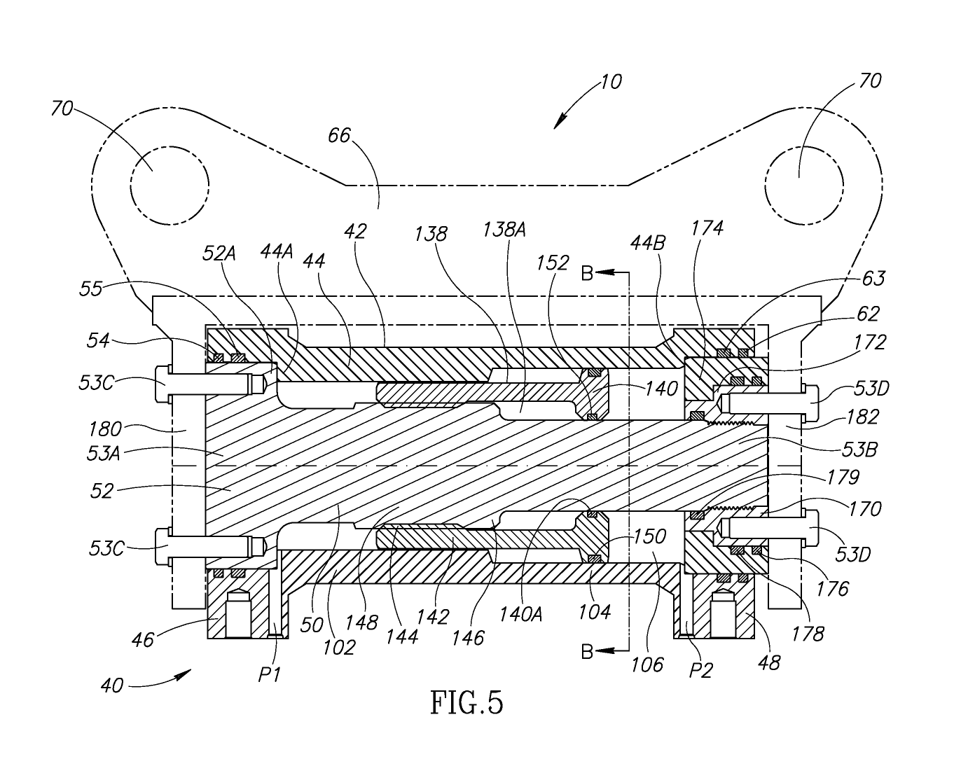

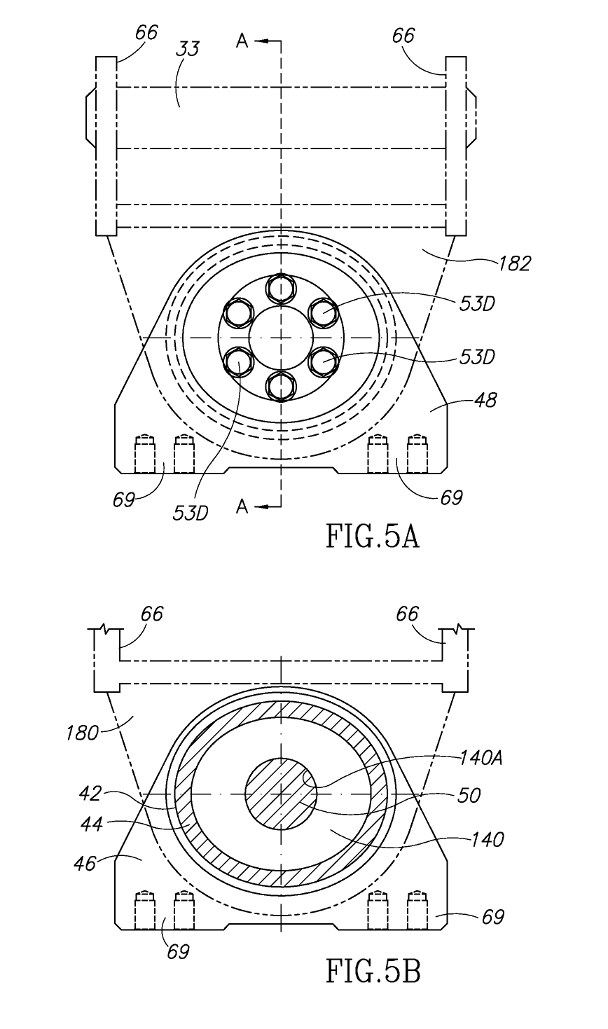

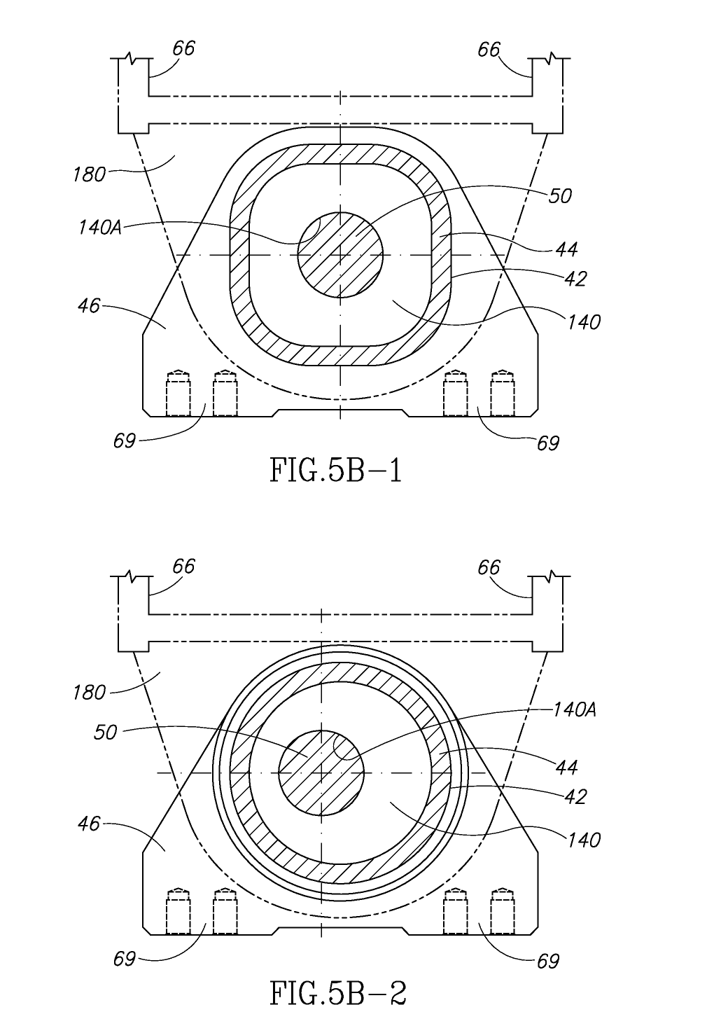

FIGS. 5 and 5A illustrate a fourth embodiment of the rotary actuator 40 useable as part of the tool assembly 10, or for other purposes, somewhat similar to the rotary actuator of FIGS. 3, 3A and 3B in that the shaft 50 extends the full length of the body 42. However, in this fourth embodiment the attachment brackets 66 are rigidly attached to the shaft 50 and not to the body 42, and the rotation of the body relative to the shaft is used to transmit rotational drive to an external device (not shown) such as an attachment frame.

The shaft 50 has the flange portion 52 at the first body end 46 with the axially inward facing flange shoulder 52A in sliding engagement with the axially outward facing first body end shoulder 44A of the body sidewall 44, which limits the axial movement of the shaft toward the second body end 48. The shaft first end portion 53A at the first body end 46 extends axially outward beyond the first body end.

The shaft 50 has the shaft second end portion 53B at the second body end 48 with a shaft nut 170 threadably attached thereto. The shaft nut 170 has a threaded interior portion threadably attached to a correspondingly threaded perimeter portion of the shaft second end portion 53B, and the shaft nut rotates with the shaft 50. The shaft nut 170 also has an axially inward facing shaft nut shoulder 172. An annular axial thrust bushing 174 having an ovalar outside surface and cylindrical inside apertures is mounted on the shaft nut 170 in position between the axially outward facing second body end shoulder 44B and the axially inward facing shaft nut shoulder 172, in sliding engagement with the shaft nut. The annular axial thrust bushing 174 limits axial movement of the shaft 50 toward the body first end 46. The shaft second end portion 53B at the second body end 48, the shaft nut 170 and the annular axial thrust bushing 174 extend axially outward beyond the second body end. An exclusion seal 176 and a pressure seal 178 are disposed between the periphery of the shaft nut 170 and radially inward surface of the annular axial thrust bushing 174 to provide a fluid-tight seal and containment seal therebetween. A seal 179 is disposed between the shaft nut 170 and the periphery of the radially inward surface of the second end portion 53B to provide a fluid-tight seal therebetween.

In this fourth embodiment, the attachment brackets 66 include a first end flange 180 and a second end flange 182, with the first end flange positioned axially outward of the body first end 46 and the second end flange positioned axially outward of the body second end 48. The first end flange 180 abuts against the outward end face of the shaft first end portion 53A and is bolted thereto by a plurality of circumferentially arranged bolts 53C (only two being illustrated in FIG. 5). The second end flange 182 abuts against the outward end face of the shaft nut 170 and is bolted thereto by a plurality of circumferentially arranged bolts 53D (only two being illustrated in FIG. 5).

The actuator 40 of this fourth embodiment has a linear-to-rotary transmission means generally as described for the rotary actuator of FIG. 3. The piston sleeve 138 is coaxially and reciprocally mounted within the body 42 with the piston head 140 located toward the second body end 48 and the splined portion 142 rigidly attached to the piston head and extending therefrom toward the first body end 46. The splined portion 142 has inner helical splines 144 over a portion of its length which slidably mesh with outer helical splines 146 of the splined intermediate portion 148 of the shaft 50 located between the shaft first and second end portions 53A and 53B, to a side of the piston head 140 toward the first body end 46.

The piston head 140 and the interior chamber 106 of this fourth embodiment may be non-cylindrical in cross-sectional shape, such as shown in FIG. 5B for an oval piston head and interior chamber and as shown in FIG. 5B-1 for an alternative square piston head and interior chamber. In both designs a concentric shaft 50 is used and the aperture 140A of the piston head 140 is located coaxial with the body 42 and the shaft 50. As will be described below for FIG. 5B-2, an alternative piston head, interior chamber and shaft design may be used.

The piston head 140 and the interior chamber 106 are positioned toward the second body end 48. The piston head 140 is slidably maintained within the body 42 for reciprocal movement, and undergoes longitudinal but not rotational movement relative to the body sidewall 44. The body sidewall 44 of the body 42 of the rotary actuator 40 of this embodiment has the first end body sidewall portion 102 being cylindrical in cross-sectional shape and extending from the first body end 46 to a body mid-portion. In the actuator designs of FIGS. 5B and 5B-1, the second end body sidewall portion 104 is non-cylindrical in cross-sectional shape (both the exterior and interior wall surfaces) and extends from axially inward of the second body end 48 to the body mid-portion where the first and second end body sidewall portions are joined together. The second end body sidewall portion 104 defines the interior chamber 106 which is non-cylindrical in cross-sectional shape and sized to slidably receive the piston head 140 therein. The interior sidewall surfaces of the first and second end body sidewall portions 102 and 104 are smooth. The piston head 140 of the piston sleeve 138 is disposed for reciprocation within only the non-cylindrical interior chamber 106 of the second end body sidewall portion 104 and has a perimeter with a cross-sectional shape corresponding to the non-cylindrical shape of the interior chamber 106 (oval or square being illustrated in FIGS. 5B and 5B-1) so as to be in sliding engagement therewith. The splined portion 142 of the piston sleeve 138 is cylindrical in shape. The piston head 140 carries the outer and inner seals 150 and 152.

As for the first embodiment described above, reciprocation of the piston sleeve 138 within the body 42 of the rotary actuator 40 occurs when hydraulic fluid under pressure selectively enters through one or the other of a first port P1 which is in fluid communication with a fluid-tight compartment within the body defined to a side of the piston head 140 toward the first body end 46 or through a second port P2 which is in fluid communication with a fluid-tight compartment within the body to a side of the piston head toward the second body end 48. The application of fluid pressure to the first port P1 produces axial movement of the piston sleeve 138 toward the second body end 48. The application of fluid pressure to the second port P2 produces axial movement of the piston sleeve 138 toward the first body end 46. The rotary actuator 40 provides relative rotational movement between the body 42 and shaft 50 through the conversion of linear movement of the piston sleeve 138 into rotational movement. In this fourth embodiment, since the attachment brackets 66 are rigidly attached to the shaft 50, not the body 42, the rotation of the body relative to the shaft is used to transmit rotational drive to an external device (not shown) such as an attachment frame. As such, in this fourth embodiment the interiorly threaded attachments 69 of the body 42 are used to attach the body to the external device to be rotatably driven by the actuator 40.

When hydraulic fluid under pressure is selectively applied to the first port P1 or the second port P2, the piston sleeve 138 will move longitudinally within the second end body sidewall portion 104, but the matching non-cylindrical shapes of the piston head 140 and the second end body sidewall portion prevent the rotation of the piston sleeve. Linear reciprocation of the piston head 140 in an axial direction within the second end body sidewall portion 104 of the body 42 of the rotary actuator 40, with the inner helical splines 144 of the splined portion 142 of the piston sleeve 138 engaging and meshing with the outer helical splines 146 of the splined intermediate portion 148 of the shaft 50, causes the body to alternately rotate clockwise and counterclockwise relative to the shaft which is rigidly attached to the attachment brackets 66. Thus, all movement of the piston sleeve 138 is converted into rotational movement of the body 42.

The axial movement of the piston sleeve 138 is converted into rotational movement of the body 42 through the interaction of the inner helical splines 144 of the splined portion 142 of the piston sleeve and the outer helical splines 146 of the splined intermediate portion 148 of the shaft 50 because axial movement of the shaft is restricted by the annular axial thrust bushing 174. During operation of the actuator 40, under an axial thrust load either the axially inward facing flange shoulder 52A of the flange portion 52 slides along the axially outward facing first body end shoulder 44A, or the axially inward facing shaft nut shoulder 172 slides along the contacted surface of the annular axial thrust bushing 174. As previously described, since the seals 55 and 178 are located axially outward of these areas of sliding engagement, the fluid applied to the first and second ports P1 and P2 to produce axial movement of the piston sleeve 138 also provides lubrication to reduce the sliding friction between the contact surfaces and the wear resulting from the body 42 rotating. Further, the location of the seals 54, 55, 176 and 178 also places the contact surfaces within the sealed interior of the body 42 and thereby prevents debris, dust, dirt and moisture in the environment from engagement therewith and the damage and wear that would cause.

In the actuator design of FIG. 5B-2, a cylindrical piston head 140 (having a round cross-sectional shape) and a cylindrical interior chamber 106 are used, however, the design uses an eccentric shaft 50 which is not coaxial with the body 42. This is compared to the non-cylindrical piston head 140 and the interior chamber 106 designs described above and shown in FIGS. 5B and 5B-1 which also use a concentric shaft 50. Except for these differences, the other aspects of the design of FIG. 5B-2 is the same.

With the cylindrical piston head 140 and interior chamber 106, when using the eccentric shaft, while the piston head is slidably maintained within the body 42 for reciprocal movement in the interior chamber, and undergoes longitudinal but not rotational movement relative to the body sidewall 44. The aperture 140A of the piston head 140 is eccentric and not coaxial with the body 42, but of course, the aperture is coaxial with the shaft 50 that extends through the aperture.

While the second end body sidewall portion 104 is cylindrical in cross-sectional shape (both the exterior and interior wall surfaces) and defines the interior chamber 106 as being cylindrical in cross-sectional shape, and while the piston head 140 is slidably receive therein for axial reciprocating movement, the piston head is restrained from rotating within the interior chamber 106 by the eccentric shaft 50. As for the designs of FIGS. 5B and 5B-1, the design of FIG. 5B-2 provides for reciprocation of the piston sleeve 138 within the body 42 of the rotary actuator 40 when hydraulic fluid under pressure selectively enters through one or the other of a first port P1 which is in fluid communication with a fluid-tight compartment within the body defined to a side of the piston head 140 toward the first body end 46 or through a second port P2 which is in fluid communication with a fluid-tight compartment within the body to a side of the piston head toward the second body end 48. The application of fluid pressure to the first port P1 produces axial movement of the piston sleeve 138 toward the second body end 48. The application of fluid pressure to the second port P2 produces axial movement of the piston sleeve 138 toward the first body end 46. The rotary actuator 40 provides relative rotational movement between the body 42 and shaft 50 through the conversion of linear movement of the piston sleeve 138 into rotational movement. As previously described for this fourth embodiment, since the attachment brackets 66 are rigidly attached to the shaft 50, not the body 42, the rotation of the body relative to the shaft is used to transmit rotational drive to an external device (not shown) such as an attachment frame.

When hydraulic fluid under pressure is selectively applied to the first port P1 or the second port P2, the piston sleeve 138 will move longitudinally within the second end body sidewall portion 104, but since the shaft 50 extending through the cylindrical piston head 140 passes through the aperture 140A at a location not concentric with the cylindrical piston head, no rotation of the piston head results, it being prevented by the eccentric shaft. Linear reciprocation of the piston head 140 in an axial direction within the second end body sidewall portion 104 does result, with the inner helical splines 144 of the splined portion 142 of the piston sleeve 138 engaging and meshing with the outer helical splines 146 of the splined intermediate portion 148 of the shaft 50, causing the body to alternately rotate clockwise and counterclockwise relative to the shaft which is rigidly attached to the attachment brackets 66. Thus, all movement of the piston sleeve 138 of the design of FIG. 5B-2 is converted into rotational movement of the body 42 as with the previously described designs of FIGS. 5B and 5B-1.

It will be appreciated that, although specific embodiments of the invention have been described herein for purposes of illustration, various modifications may be made without departing from the spirit and scope of the invention. Accordingly, the invention is not limited except as by the appended claims.

I claim:

1. A fluid-powered rotary actuator, comprising:
a body having a longitudinal axis, and first and second body ends, said body having a first end body portion extending from said first body end partially toward said second body end and a second end body portion extending from inward of said second body end partially toward said first body end, said first end body portion defining an interior first end chamber and said second end body portion defining an interior second end chamber, at least an axially inward portion of said second end body portion having interior walls with a non-cylindrical cross-sectional shape, said first end body portion having a first shoulder facing axially outward toward said first body end and said second end body portion having a second shoulder facing axially outward toward said second body end;
an output shaft rotatably disposed within said first end body portion for rotation of said shaft within said first end body portion to produce relative rotational movement between said shaft and said body, said shaft having a first shaft end portion located within said first end body portion toward said first body end and a second shaft end portion located within said first end body portion away from said first body end, said first shaft end portion having a flange portion toward said first body end engaging said first shoulder of said first end body portion to inhibit axial movement of said shaft toward said second body end, and said second shaft end portion having an aperture therein with an opening facing toward said second body end;
a linear-to-rotary torque transmitting member mounted for longitudinal movement within said body in response to the selective application of pressurized fluid thereto, said torque-transmitting member having a piston head and a drive member, said piston head disposed within said non-cylindrical cross-sectional portion of said second end body portion in sliding engagement therewith, said piston head having a non-cylindrical cross-sectional shape sized to engage said second end portion body to inhibit rotation of said piston head in said second end portion body, said drive member extending from said piston head toward said first body end and into said aperture of said second shaft end portion and drivingly engaging said second shaft end portion to translate longitudinal movement of said piston head into clockwise and counterclockwise of said shaft relative to said body;
an end member rotatably disposed within said second end body portion toward second body end for rotation of said end member in response to rotation of said shaft, said end member engaging said second shoulder of said second end body portion to inhibit axial movement of said end member toward said first body end; and
a saddle member positioned outward of said body and having a first leg located at said first body end and attached to said first shaft end portion for rotation therewith and to inhibit axially outward movement of said shaft toward said first body end and retain said shaft within said first end body portion, a second leg located at said second body end and attached to said end member to inhibit axially outward movement of said end member toward said second body end and retain said end member within said second end body portion, and a connector member extending between said first and second legs and maintaining said first and second legs in position at said first and second body ends.

2. The rotary actuator of claim 1 wherein said flange portion of said first shaft end portion has a circumferential wall portion for sliding rotary engagement with a circumferential wall portion of said first end body portion axially outward of and adjacent to said first shoulder, and said end member has a circumferential wall portion for sliding rotary engagement with a circumferential wall portion of said second end body portion axially outward of and adjacent to said second shoulder, whereby said engagement with said circumferential wall portions provide radial load transfer.

3. The rotary actuator of claim 1 further including:
a first seal positioned between said flange portion of said first end body portion axially outward of said first shoulder toward said first body end; and
a second seal positioned between said end member and said second end body portion axially outward of said second shoulder toward said second body end, whereby the pressurized fluid selectively applied to said linear-to-rotary torque transmitting member lubricates said first and second shoulders.

4. The rotary actuator of claim 1 wherein said non-cylindrical cross-sectional shape of said piston head corresponds to said non-cylindrical cross-sectional shape of said second end body portion.

5. A fluid-powered rotary actuator, comprising:
a body having a longitudinal axis, and first and second body ends, said body having a first end body portion extending from said first body end partially toward said second body end and a second end body portion extending from said second body end partially toward said first body end, said first end body portion defining an interior first end chamber and said second end body portion defining an interior second end chamber, at least an axially inward portion of said second end body portion having interior walls with a non-cylindrical cross-sectional shape;
an output shaft rotatably disposed within said body for rotation of said shaft to produce relative rotational movement between said shaft and said body, said shaft having a first shaft end portion located within said first end body portion and a second shaft end portion located within said second end body portion, said first shaft end portion having a first shoulder toward said first body end facing axially outward toward said first body end and said second shaft end portion having a second shoulder toward said second body end facing axially outward toward said second body end;
a first end cap secured to said first end body portion toward said first body end and positioned axially outward of said first shoulder of said first shaft end portion toward said first body end, said first end cap having a first aperture with said first shaft end portion extending into said first aperture;
a second end cap secured to said second end body portion toward said second body end and positioned axially outward of said second shoulder of said second shaft end portion toward said second body end, said second end cap having a second aperture with said shaft end portion extending into said second aperture;
a first annular axial thrust bearing positioned on said first shaft end portion between said first end cap and said first shoulder of said first shaft end portion to inhibit axial movement of said shaft toward said first body end;
a second annular axial thrust bearing positioned on said second shaft end portion between said second end cap and said second shoulder of said second shaft end portion to inhibit axial movement of said shaft toward said second body end; and
a linear-to-rotary torque transmitting member mounted for longitudinal movement within said body in response to the selective application of pressurized fluid thereto, said torque-transmitting member having a piston head and a drive member, said piston head disposed within said non-cylindrical cross-sectional portion of said second end body portion in sliding engagement therewith and having an aperture with said second shaft end portion extending therethrough, said piston head having a non-cylindrical cross-sectional shape sized to engage said second end portion body to inhibit rotation of said piston head in said second end portion body, said drive member extending from said piston head toward said first body end and having an aperture with said first shaft end portion extending therethrough, said drive member drivingly engaging said first shaft end portion to translate longitudinal movement of said piston head into clockwise and counterclockwise of said shaft relative to said body.

6. The rotary actuator of claim 5 further including:
a first seal positioned between said first end cap and said first shaft end portion, axially outward of said first axial thrust bearing; and
a second seal positioned between said second end cap and said second shaft end portion axially outward of said second axial thrust bearing, whereby the pressurized fluid selectively applied to said linear-to-rotary torque transmitting member lubricates said first and second axial thrust bearings.

7. A fluid-powered rotary actuator, comprising:
a body having a longitudinal axis, and first and second body ends, said body having a first end body portion extending from said first body end partially toward said second body end and a second end body portion extending from inward of said second body end partially toward said first body end, said first end body portion defining an interior first end chamber and said second end body portion defining an interior second end chamber, at least an axially inward portion of said second end body portion having interior walls with a non-cylindrical cross-sectional shape, said first end body portion having a first shoulder facing axially outward toward said first body end;
an output shaft rotatably disposed within said first end body portion for rotation of said shaft within said first end body portion to produce relative rotational movement between said shaft and said body, said shaft having a first shaft end portion located within said first end body portion toward said first body end and a second shaft end portion located within said first end body portion away from said first body end, said first shaft end portion having a flange portion toward said first body end engaging said first shoulder of said first end body portion to inhibit axial movement of said shaft toward said second body end, and said second shaft end portion having an aperture therein with an opening facing toward said second body end;
a linear-to-rotary torque transmitting member mounted for longitudinal movement within said body in response to the selective application of pressurized fluid thereto, said torque-transmitting member having a piston head and a drive member, said piston head disposed within said non-cylindrical cross-sectional portion of said second end body portion in sliding engagement therewith, said piston head having a non-cylindrical cross-sectional shape sized to engage said second end portion body to inhibit rotation of said piston head in said second end portion body, said drive member extending from said piston head toward said first body end and into said aperture of said second shaft end portion and drivingly engaging said second shaft end portion to translate longitudinal movement of said piston head into clockwise and counterclockwise of said shaft relative to said body;
a first end cap secured to said first body end portion toward said first body end and axially outward of said flange portion of said first shaft end portion, and engaging said flange portion to inhibit axially movement of said shaft toward said first body end and retaining said shaft within said first end body portion, said first end cap having an aperture with said first shaft end portion extending into said aperture; and
a second end cap secured to said second end body portion toward said second body end.

8. A fluid-powered rotary actuator, comprising:
a body having a longitudinal axis, and first and second body ends, said body having a first end body portion extending from said first body end partially toward said second body end and a second end body portion extending from said second body end partially toward said first body end, said first end body portion defining an interior first end chamber and said second end body portion defining an interior second end chamber, at least an axially inward portion of said second end body portion having interior walls with a non-cylindrical cross-sectional shape, said first end body portion having a first shoulder facing axially outward toward said first body end and said second end body portion having a second shoulder facing axially outward toward said second body end;
an output shaft rotatably disposed within said body for rotation of said shaft to produce relative rotational movement between said shaft and said body, said shaft having a first shaft end portion located within said first end body portion and a second shaft end portion located within said second end body portion, said first shaft end portion having a flange portion toward said first body end engaging said first shoulder of said first end body portion to inhibit axial movement of said shaft toward said second body end and said second shaft end portion having a threaded end portion toward said second body end;
a shaft nut threadably secured to said threaded end portion of said second shaft end portion for rotation therewith, said shaft nut having a third shoulder facing axially inward toward said first body end;
an annular axial thrust bearing positioned between and in engagement with said second shoulder of said second end body portion and said third shoulder of said shaft nut to inhibit axially movement of said shaft toward said first body end; and
a linear-to-rotary torque transmitting member mounted for longitudinal movement within said body in response to the selective application of pressurized fluid thereto, said torque-transmitting member having a piston head and a drive member, said piston head disposed within said non-cylindrical cross-sectional portion of said second end body portion in sliding engagement therewith and having an aperture with said second shaft end portion extending therethrough, said piston head having a non-cylindrical cross-sectional shape sized to engage said second end portion body to inhibit rotation of said piston head in said second end portion body, said drive member extending from said piston head toward said first body end and having an aperture with said first shaft end portion extending therethrough, said drive member drivingly engaging said first shaft end portion to translate longitudinal movement of said piston head into clockwise and counterclockwise of said shaft relative to said body.

9. A fluid-powered rotary actuator, comprising:
a body having a longitudinal axis, and first and second body ends, said body having a first end body portion extending from said first body end partially toward said second body end and a second end body portion extending from said second body end partially toward said first body end, said first end body portion defining an interior first end chamber and said second end body portion defining an interior second end chamber, said first end body portion having a first shoulder facing axially outward toward said first body end and said second end body portion having a second shoulder facing axially outward toward said second body end;
an eccentric output shaft rotatably disposed within said body for rotation of said shaft to produce relative rotational movement between said shaft and said body, said shaft having an axis of rotation spaced laterally from said longitudinal axis of said body, said shaft having a first shaft end portion located within said first end body portion and a second shaft end portion located within said second end body portion, said first shaft end portion having a flange portion toward said first body end engaging said first shoulder of said first end body portion to inhibit axial movement of said shaft toward said second body end and said second shaft end portion having a threaded end portion toward said second body end;
a shaft nut threadably secured to said threaded end portion of said second shaft end portion for rotation therewith, said shaft nut having a third shoulder facing axially inward toward said first body end;
an annular axial thrust bearing positioned between and in engagement with said second shoulder of said second end body portion and said third shoulder of said shaft nut to inhibit axially movement of said shaft toward said first body end; and
a linear-to-rotary torque transmitting member mounted for longitudinal movement within said body in response to the selective application of pressurized fluid thereto, said torque-transmitting member having a piston head and a drive member, said piston head disposed within second end body portion in sliding engagement therewith and having a first eccentric aperture with said second shaft end portion extending therethrough, said first eccentric aperture inhibiting rotation of said piston head in said second end portion body, said drive member extending from said piston head toward said first body end and having a third eccentric aperture with said first shaft end portion extending therethrough, said drive member drivingly engaging said first shaft end portion to translate longitudinal movement of said piston head into clockwise and counterclockwise of said shaft relative to said body.
